(19) United States
(12) Patent Application Publication
(10) Pub. No.: US 2008/0154711 A1
(43) Pub. Date: Jun. 26, 2008

(54) Availability Tracker

(75) Inventors: Maneet Singh Sahni, Haryana (IN); Gaurav Chauhan, New Delhi (IN); Aayush Bhatnagar, Weston, FL (US); Sandeep Bhasin, Haryana (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/615,697

(22) Filed: Dec. 22, 2006

(51) Int. Cl. H04M 3/51

(52) U.S. Cl. 705/11

(57) ABSTRACT

The present invention provides a system, method and computer program product for tracking the availability of an employee. Various details relating to each activity undertaken by the employee are captured. The captured details may be used to monitor the activities currently being undertaken by the employee, generating reports detailing the time spent by the employee on various activities; availability of the employee and the like.

### BACKGROUND OF THE INVENTION

1. Field of the Invention

The present invention generally relates to management information systems. More particularly, the invention relates to tracking the availability of employees in an organization.

2. Related Art

In managing employees, it is desirable to track how the employees spend their time. Such tracking is useful for determining employee availability. As used herein, the term “availability” includes, for example, one or more of the following parameters: tasks, including projects and processes being performed, time spent on a particular task, efficiency, productivity, output, downtime, and the like. Such information can be used by managers, for example, to evaluate labor costs, schedule employees to meet labor demands (i.e., provide appropriate staffing), evaluate individual and group productivity, etc. Collection and analysis of such information, however, is tedious and time consuming.

Such information can be manually provided by each employee on a periodic basis (e.g., daily, weekly, monthly, etc.). The information is collected, collated and analysed by the team leaders to prepare reports detailing availability. However, such a process is time-consuming, error-prone, and subject to manipulation. Moreover, as the number of employees in an organization increases, it becomes even more difficult for team leaders (i.e., managers) to personally track such information.

Given the foregoing, what is needed is a system and method for tracking the availability of employees in an efficient and accurate manner. Further, the system should be able to track the availability of employees in real time, with reduced possibility of error. The system should reduce the effort spent by team leaders in tracking availability of employees. Additionally, the system should automate the process of collating availability information and report generation.

### BRIEF DESCRIPTION OF THE DRAWINGS/FIGURES

The features and advantages of the present invention will become more apparent from the detailed description set forth below, when taken in conjunction with the drawings, in which like reference numbers indicate identical or functionally similar elements. Additionally, the left most digit of a reference number identifies the drawing in which the reference number first appears.

FIG. 1 is a block diagram of an exemplary system, in accordance with an embodiment of the invention.

FIG. 2 is a flowchart illustrating a process for tracking the availability of an employee, in accordance with an embodiment of the invention.

FIG. 3 is a flowchart illustrating a process for tracking the availability of an employee, in accordance with an exemplary embodiment of the invention.

FIG. 4 is a block diagram of an exemplary computer system useful for implementing the invention.

### DETAILED DESCRIPTION OF THE INVENTION

### I. Overview

The present invention is directed to a system and method for tracking the availability of an employee in an organization. The system records with high accuracy the time spent by an employee on various activities. The system is initiated the moment an employee logs onto a computer system. Details about each activity undertaken by the employee, such as the start and end time of the activity are captured by the system. Details about various activities and the time spent on each activity by the employee are stored and may be presented in the form of reports to team leaders, to assess employee availability (e.g., tasks being performed, time spent on a particular task, efficiency, productivity, output, downtime, and/or the like). Further, the system may be invoked each time the employee undertakes a new activity.

The present invention is now described in more detail herein in terms of the above exemplary embodiment. This is for convenience only and is not intended to limit the application of the present invention. In fact, after reading the following description, it will be apparent to one skilled in the relevant art(s) how to implement the following invention in alternative embodiments (e.g., various formats in which the information is being converted, various software and hardware platforms being used, the mode of implementation of the invention, end use of the invention etc.).

The terms “employee”, “team member”, and/or the plural form of these terms are used interchangeably throughout herein to refer to those persons or entities capable of accessing, using, be affected by and/or benefiting from the tool that the present invention provides for tracking the availability of employees in an organization. Similarly, the terms “team leader”, “manager”, and/or the plural form of these terms are used interchangeably throughout herein to refer to those persons or entities capable of accessing, using, be affected by and/or benefiting from the tool that the present invention provides for tracking the availability of employees in an organization.

### II. System

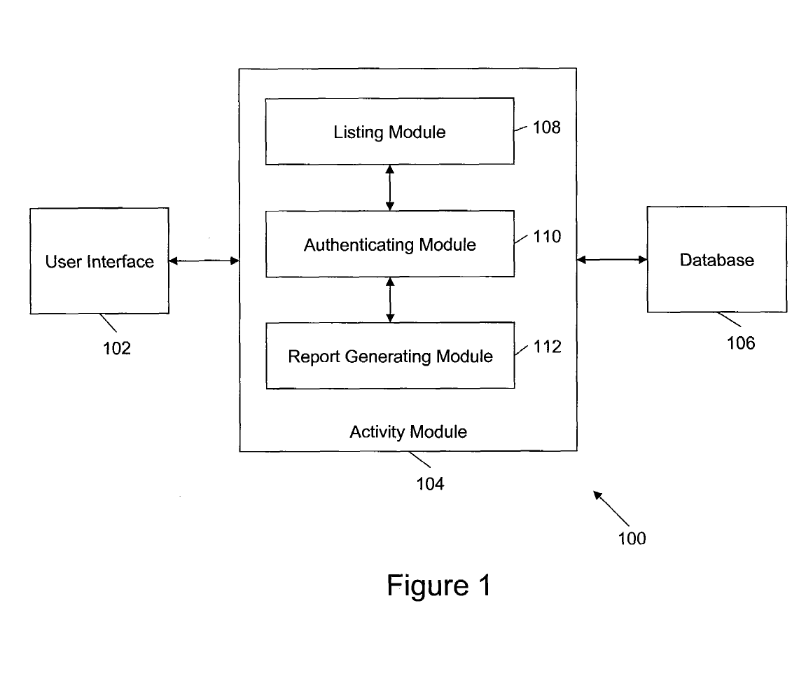

Referring to FIG. 1, a system diagram of an exemplary system 100 for tracking the availability of an employee, in which the present invention, in an embodiment, would be implemented, is shown.

In accordance with an embodiment of the invention, system 100 is used to track the availability of an employee in an organization. System 100 includes a user interface 102, an activity module 104, and a database 106. Activity module 104 includes a listing module 108, an authenticating module 110, and a report generating module 112.

User interface 102 displays information to an employee who accesses system 100. The information displayed by user interface 102 may include information related to, for example, activities the employee may wish to undertake and/or details of various activities undertaken by the employee over a specified period of time. The information related to activities may include the activity name, activity type, and activity code. Details of the various activities undertaken by the employee may include, for example, the start and end time of each activity undertaken, the time spent on each activity over a specified period of time, activity details, and the like. User interface 102 may be used by the employee, for example, to select an activity to be undertaken and to confirm details such as login time, time spent on a particular activity, and the like. Examples of activities (i.e., activity names) include production, transaction, break, meeting, training, presentation, seminar, login, logoff, and the like. Examples of activity types include productive activity, non-productive activity, and the like.

Activity module 104 tracks the availability of an employee over a period of time. Listing module 108 includes a list of activities that may be undertaken by an employee. In various embodiments of an invention, a team leader may specify a list of activities that may be undertaken by each employee in listing module 108. The list of activities may be displayed on user interface 102, to an employee. Authenticating module 110 includes one or more rights for employees, team leaders and administrators. Further, authenticating module 110 includes authentication information for employees, team leaders and administrators in order to access system 100. In various embodiments of the invention, team leaders may modify information about their team, such as adding on or modifying team members. In addition, team leaders may monitor the activities undertaken by employees in real time. Administrators may change information relating to the activities undertaken by employees, if requested by the appropriate team leaders.

In an embodiment of the invention, if a team leader is on leave, another team leader may acquire rights of the team leader and thereby monitor the team of the team leader on leave. The rights may be allotted back when the team leader returns. Further, in various embodiments of the invention, team leaders may have rights to view reports associated with employee availability.

Report generating module 112 generates various reports detailing the time spent by employees on various activities over a period of time. For example, report generating module 112 may be utilized to generate the time spent on various activities by a particular employee over a time period such as a day, a week, or a month. In various embodiments of the invention, an employee may view a report detailing the time spent by him/her on a particular activity over a specified period of time. Report generating module 112 may also be utilized in order to generate a report of the total productive time spent by an employee over a specified period of time. For example, in an embodiment of the invention, an employee may view the total number of hours spent by him/her on productive activities over a week.

In various embodiments of the invention, report generating module 112 may be used by team leaders to view a current status report, as well as, system time-view reports of various team members. The current status report provides details of the activities currently undertaken by the various team members. The system time-view reports detail the time spent by one or more team members on various activities over a specified period of time. Further, report generating module 112 may be used to generate reports detailing employee availability, including employee productivity, etc. The reports generated may be utilized, for example, to analyze the availability of an employee over a period of time, for scheduling activities for the employee, and the like.

Reports generated using report generating module 112 may be viewed in a web-based format, or may be exported to other applications such as Microsoft MS Excel®, Lotus Notes®, and the like. Further, reports generated using report generating module 112 may include various graphs depicting, for example, the time spent by an employee on one or more activities over a specified period of time, productivity, availability, efficiency, and the like. In various embodiments of the invention, the team leader may monitor current status and various other reports of employees from a remote location.

Database 106 stores details of the time spent by employees on various activities. In various embodiments of the invention, database 106 may interact with listing module 108 and report generating module 112 in order to store the time spent by each employee on each activity, the allocated time to be spent by each employee on each activity, a list of employees forming a part of various teams, a list of team leaders associated with the various teams, and the like. Database 106 may store a list of activities associated with each employee, for example, one or more productive tasks, break time, meetings, presentations, trainings, seminars, and the like. In various embodiments of the invention, administrators may change data stored in database 106 relating to a particular employee, after receiving an approval from a team leader.

In accordance with various embodiments of the invention, user interface 102 may be, for example, a Graphical User Interface (GUI), an Application Program Interface (API), and the like. Further, user interface 102 may be implemented by using, for example, Hyper Text Markup Language (HTML) documents, Java applets, Javascripts, Active Server Pages (ASP), Common Gateway Interface (CGI) scripts, extensible markup language, dynamic HTML, Cascading Style Sheets (CSS), plug-ins, and the like.

Database 106 may be, for example, a Structured Query Language (SQL) 7.0 server, an Oracle server, and the like.

In various embodiments of the invention, system 100 may be implemented in a single data-processing system, or in a network of data-processing systems. Examples of data-processing systems include computers, Personal Digital Assistants (PDA), mobile phones, and the like.

### III. Process

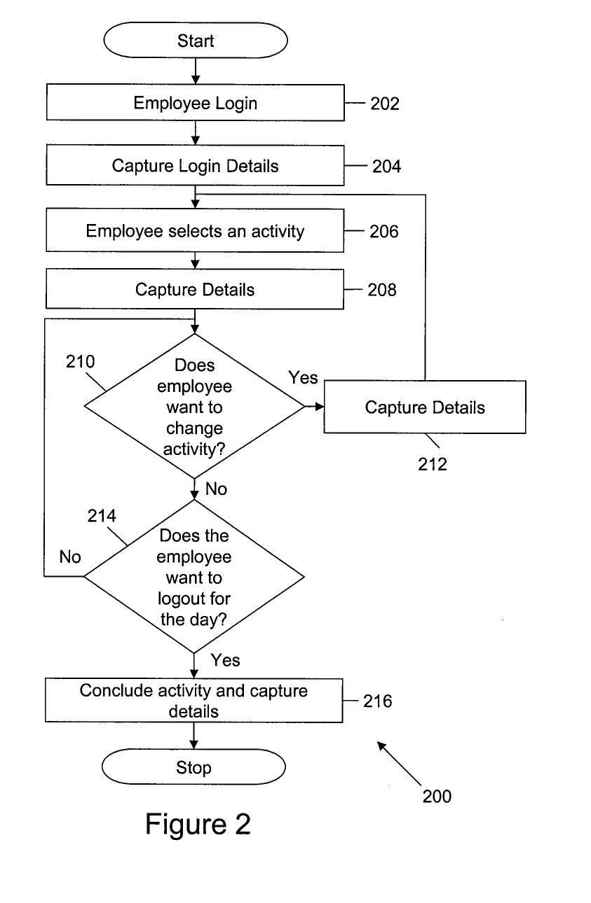

Referring to FIG. 2, a flowchart illustrating a process 200 for tracking the availability of an employee, according to one embodiment of the present invention, is shown.

Process 200 begins at step 202, where an employee logs into a computer system. In various embodiments of the invention, the employee may use authentication information in order to log on to the computer system. At step 204, login details of the employee are captured. In various embodiments of the invention, login details may include the date and time of login, employee details, team details, and the like. Employee details may include employee code, name of the employee, and the like. Team details may include name of the team, name and employee code of a team leader under whom the employee is currently working, and the like. In various embodiments of the invention, a user interface may be used in order to login to the computer system. In an embodiment of the invention, user interface 102 is used to login to the computer system. The login details are stored in database 106.

At step 206, the employee selects an activity to undertake. In various embodiments of the invention, the user interface may display a list of activities that an employee may select. The list of activities displayed may be allocated to the employee by a team leader. The user interface may display the details of an activity, such as name of the activity, activity code, activity type, and the like. Activity type may include productive activity, non-productive activity, and the like. Examples of activities include various productive activities such as production, projects, processes, and meetings, and non-productive activities such as breaks, presentations, seminars, and the like.

In accordance with an embodiment of the invention, a list of activities that the employee can undertake may be available in listing module 108. The team leader may modify the list of activities in listing module 108, using rights specified in authenticating module 110. The list of activities may be displayed by user interface 102. Each activity is accompanied by a corresponding activity code.

At step 208, the details of the selected activity are captured and stored. In various embodiments of the invention, the date and the time of start of the selected activity, employee details, activity details, and the like may be captured and stored. In an embodiment of the invention, database 106 is used to store the details of the selected activity.

At step 210, it is checked whether the employee wants to conclude the activity and undertake another activity. If the employee wants to conclude the activity, step 212 is performed. At step 212, details of the concluded activity are captured and stored. In various embodiments of the invention, the date and time of the conclusion of the activity, employee details, activity details, and the like may be captured and stored. In an embodiment, the details of the concluded activity may be stored in database 106. Thereafter, step 206 is performed, and the employee may select another activity to undertake. If, at step 210, the employee does not want to conclude the activity, step 214 is performed. At step 214, it is checked whether the employee wants to logout for the day. If the employee wants to logout, step 216 is performed.

At step 216, the activity currently being performed by the employee is concluded, and details of the concluded activity are captured and stored. In various embodiments of the invention, the details captured and stored may include the date and time of the conclusion of the activity, employee details, activity details, and the like. Further, details about the logout, such as the date and the time of logout may be captured and stored.

In various embodiments of the invention, an employee may activate the user interface whenever a change of activity is desired. For example, the employee may activate the user interface when the employee decides to take a break. The user interface may display the current time and prompt the employee to select a reason for taking a break. Once the activity ‘break’ is selected, the computer system may be deactivated. When the employee returns from the break, the user interface may be activated again and may display the time of return and prompt the employee for a reason for the change of activity. In an embodiment on the invention, the employee may proceed further only after a reason for change of activity is selected in the user interface.

In various embodiments of the invention, the date, the time and reasons for the change of activities may be stored in a database, in order to process them to generate various reports. The reports generated may detail the time spent by the employee on a particular activity over a specified period of time. In an embodiment of the invention, various reports detailing the productivity measures of an employee, the current status and availability report of the employee, and the like may be generated by report generating module 112, in conjunction with database 106. The current status and availability report may detail the activity being undertaken currently by the employee, in order to give an indication of whether the employee is working on a computer system, or is taking a break, and the like.

In various embodiments of the invention, the reports generated may include various graphs depicting, for example, the time spent by an employee on one or more activities over a specified period of time, productivity, availability, efficiency, and the like. Further, the reports generated may be utilized to analyze the availability of an employee over a period of time, for scheduling activities for the employee, and the like.

### IV. Example Implementation

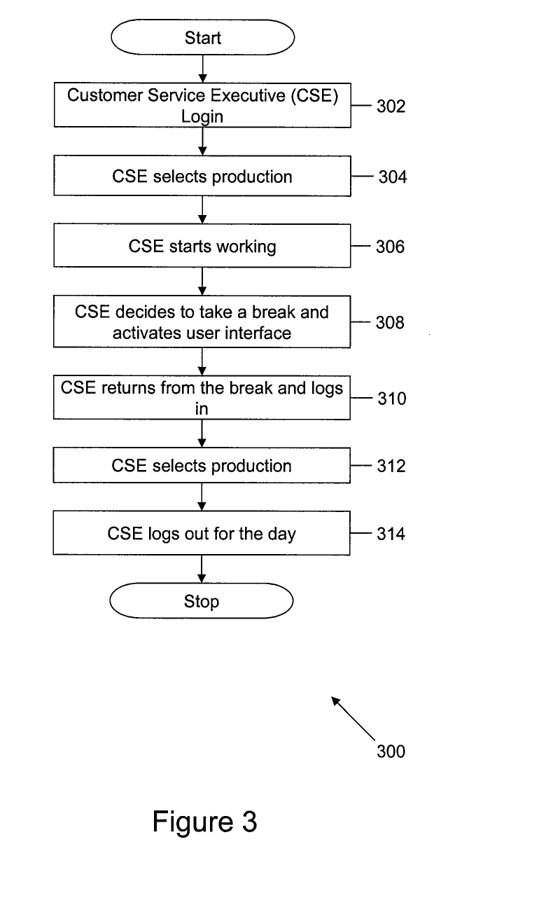

The working of various modules of system 100 has been explained herein by means of FIG. 3. FIG. 3 is a flowchart illustrating a process 300 depicting an exemplary embodiment of the invention. Process 300 starts at step 302, where a Customer Service Executive (CSE) logs onto a computer system. A user interface is activated automatically upon login. The user interface displays the login details, including the date and time of login, as captured from the computer system. The CSE has to accept the displayed details in order to proceed further. Upon acceptance, the login details and employee details are stored in a database. The user interface thereafter displays a list of activities with corresponding activity codes that the CSE can undertake.

At step 304, the CSE selects ‘production’ as an activity to be undertaken by, for example, using a mouse to click on the corresponding activity code shown on a user interface of a display device. The date and the start time of the ‘production’, along with the activity details and the CSE's employee details are captured and stored in the database. Thereafter, the user interface is minimized automatically. At step 306, the CSE starts working on the selected activity.

At step 308, the CSE decides to take a break and activates the user interface in order to change the activity to ‘break’. This is done, for example, by selecting the appropriate activity code for break activity. The production activity is concluded and the date and the time of conclusion of production activity, along with the production activity details and CSE's employee details are captured and stored in the database. Further, the date and start time the break activity is captured and stored in the database.

At step 310, the CSE returns from the break and logs onto the computer system. Upon login, the user interface is activated and the login details are displayed. The CSE accepts the login details and proceeds further. The login details, such as the date and the time of login are stored in the database. The user interface displays the list of activities that the CSE can undertake, with corresponding activity codes. At step 312, the CSE selects production activity again, by clicking on the corresponding activity code. The date and the start time of the production activity, along with the CSE employee details are captured and stored in the database. At step 320, the CSE decides to log out for the day and activates the user interface and selects the log out activity code to log out for the day. The log out details, such as date and the time of log out, are captured and stored in the database.

In various embodiments of the invention, a check may be performed to determine whether an appropriate activity code has been selected by the CSE, when a change of activity is desired. In an embodiment of the invention, if an appropriate activity code has not been selected by the CSE, the team leader may be notified, and may thereby immediately ensure that the CSE selects the appropriate activity code.

In another embodiment of the invention, the user interface may accept an inappropriate activity code and details of the inappropriate activity, such as the date and the time of selection, activity details, and the like may be stored in the database. The team leader, upon viewing availability reports of the CSE, may ensure that appropriate action is taken. Alternatively, the team leader may monitor the current status of the CSEs in real time, and may therefore ensure that each CSE selects the appropriate activity code(s).

In various embodiments of the invention, the CSE and the team leader may not be allowed to change captured information, such as activity undertaken, time of duration of undertaken activity, and the like. The team leader may request the administrator for changing the desired information.

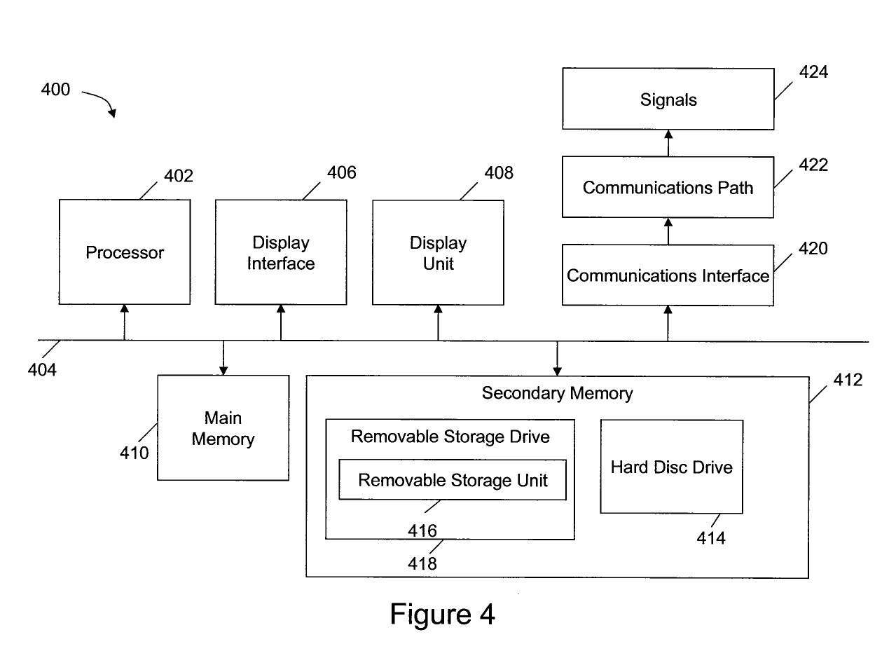

The present invention (i.e., system 100, process 200 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. An example of a computer system 400 is shown in FIG. 4.

Computer system 400 includes one or more processors, such as processor 402. Processor 402 is connected to a communication infrastructure 404 (e.g., a communication bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 406 that forwards graphics, text, and other data from communication infrastructure 404 (or from a frame buffer not shown) for display on a display unit 408.

Computer system 400 also includes a main memory 410, preferably random access memory (RAM), and may also include a secondary memory 412. Secondary memory 412 may include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a well known manner. Removable storage unit 418 represents a floppy disk, magnetic tape, optical disk, etc., which is read by and written to by removable storage drive 416. As will be appreciated, removable storage unit 418 includes a computer usable storage medium having stored therein computer software and/or data.

In alternative embodiments, secondary memory 412 may include other similar devices for allowing computer programs or other instructions to be loaded into computer system 400. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system 400.

Computer system 400 may also include a communications interface 420. Communications interface 420 allows software and data to be transferred between computer system 400 and external devices. Examples of communications interface 420 may include a modem, a network interface (such as an Ethernet card), a communications port, a Personal Computer Memory Card International Association (PCMCIA) slot and card, etc. Software and data transferred via communications interface 420 are in the form of signals 424 which may be electronic, electromagnetic, optical or other signals capable of being received by communications interface 420. These signals 424 are provided to communications interface 420 via a communications path (e.g., channel) 422. This communications path 422 carries signals 424 and may be implemented using wire or cable, fiber optics, a telephone line, a cellular link, an radio frequency (RF) link and other communications channels.

In this document, the terms ‘computer program medium’ and ‘computer usable medium’ are used to generally refer to media such as removable storage drive 416, a hard disk installed in hard disk drive 414, and signals 424. These computer program products provide software to computer system 400. The invention is directed to such computer program products.

Computer programs (also referred to as computer control logic) are stored in main memory 410 and/or secondary memory 412. Computer programs may also be received via communications interface 420. Such computer programs, when executed, enable computer system 400 to perform the features of the present invention, as discussed herein. In particular, the computer programs, when executed, enable processor 402 to perform the features of the present invention. Accordingly, such computer programs represent controllers of computer system 400.

In an embodiment where the invention is implemented using software, the software may be stored in a computer program product and loaded into computer system 400 using removable storage drive 416, hard disk drive 414 or communications interface 420. The control logic (software), when executed by processor 402, causes processor 402 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for tracking one or more activities undertaken by an employee, the method comprising:
(a) selecting an activity from the one or more activities;
(b) capturing details relating to the activity; and
(c) storing information relating to the activity, the information including the details captured.

2. The method of claim 1, wherein the capturing step comprises:
(a) capturing at least one of the start-time and the end-time of the activity.

3. The method of claim 1, further comprising:
(a) generating one or more reports relating to one or more activities undertaken by the employee over a specified time.

4. The method of claim 3, further comprising:
(a) generating a current status report of the employee.

5. A system for tracking one or more activities of an employee, the system comprising:
(a) an activity module capturing details relating to each of the one or more activities undertaken by the employee; and
(b) a database storing information relating to each activity undertaken by the employee, the information comprising the details captured by the activity module.

6. The system of claim 5, wherein the captured details comprise at least one of the start-time and the end-time of each of the one or more activities undertaken by the employee.

7. The system of claim 6, wherein the captured details comprise at least one of an activity code and an activity type corresponding to each activity undertaken by the employee.

8. The system of claim 5, wherein the database further stores employee details of the employee.

9. The system of claim 8, wherein the employee details comprise an employee code of the employee.

10. The system of claim 5, wherein the activity module further captures at least one of the login-time and the logoff-time of the employee.

11. The system of claim 5, wherein the activity module further comprises a listing module providing a list of activities for the employee.

12. The system of claim 5, wherein the activity module further comprises an authenticating module providing authentication information of the employee.

13. The system of claim 5, wherein the activity module further comprises a report generating module generating one or more reports relating to one or more activities undertaken by the employee over a specified time.

14. The system of claim 13, wherein the report generating module further generates a current status report of the employee.

15. A computer program product comprising a computer usable medium having control logic stored therein for causing a computer to track one or more activities undertaken by an employee, said control logic comprising:
(a) first computer readable program code means for allowing selection of an activity from the one or more activities;
(b) second computer readable program code means for causing a computer to capture details relating to the activity; and
(c) third computer readable program code means for causing the computer to store information related to the activity, the information including the details captured.

16. The computer program product of claim 15, further comprising:
(a) a fourth computer readable program code means for causing a computer to generate one or more reports relating to one or more activities undertaken by the employee over a specified time.

17. The computer program product of claim 15, further comprising:
(a) a fifth computer readable program code means for causing a computer to capture at least one of the start-time and the end-time of the activity.
